(19) United States
(12) Patent Application Publication
(10) Pub. No.: US 2013/0069480 A1
(43) Pub. Date: Mar. 21, 2013

(54) ELECTROMECHANICAL TRANSDUCER AND METHOD OF MANUFACTURING THE ELECTROMECHANICAL TRANSDUCER

(71) Applicants: Takahiro Akiyama, Kawasaki-shi (JP); Kazutoshi Torashima, Yokohama-shi (JP)

(72) Inventors: Takahiro Akiyama, Kawasaki-shi (JP); Kazutoshi Torashima, Yokohama-shi (JP)

(73) Assignee: CANON KABUSHIKI KAISHA, Tokyo (JP)

(21) Appl. No.: 13/592,416

(22) Filed: Aug. 23, 2012

(30) Foreign Application Priority Data
Sep. 16, 2011 (JP) 2011-202494

(51) Int. Cl. H02N 11/00; H04R 31/00

(52) U.S. Cl. 310/300; 29/602.1

(57) ABSTRACT

An electromechanical transducer with less characteristic variation and a method of manufacturing the electromechanical transducer is provided. The electromechanical transducer has a plurality of cells constituted of a first electrode, a vibration film provided with a second electrode provided so as to face the first electrode through a gap, and a supporting portion supporting the vibration film. A structure configured to reduce an uneven flatness between the vibration film and the supporting portion is provided at an outer peripheral portion of a gap while a portion of the supporting portion is interposed between the structure and the gap.

### BACKGROUND OF THE INVENTION

1. Field of the Invention

The present invention relates to an electromechanical transducer such as a capacitive micromachined ultrasonic transducer, which performs at least one of transmitting and receiving an elastic wave such as an ultrasonic wave, and a method of manufacturing the electromechanical transducer.

2. Description of the Related Art

An ultrasound transducer performs at least one of transmitting and receiving an ultrasonic wave, which is used in a diagnosis device for a tumor in an organism, for example. Recently, the development of a capacitive micromachined ultrasonic transducers (CMUT) produced by using a micromachining technique has been progressed. The superiority of CMUT, as compared with a conventional ultrasound transducer utilizing a piezoelectric substance, can be found in the aspects that: broadband characteristics are easily obtained, a vibration mode is small, and noise is small. The CMUT has a feature of transmitting or receiving an ultrasonic wave using a lightweight vibration film. Consequently, ultrasound diagnosis utilizing the CMUT to realize higher accuracy than a conventional medical diagnosis modality has attracted attention as a promising technique.

As one of methods for manufacturing the CMUT, a surface micromachining technique characterized by sacrificial layer etching is used therein. In the surface micromachining technique, an advanced technique for control of thin film stress is required as well as the sacrificial layer etching. Especially, in the CMUT, since a single element including at least one cell is constituted of a plurality of vibration films which are the thin film, the performance of the CMUT is determined by magnification of stress distribution in the vibration film. In addition to the CMUT, chemical vapor deposition (CVD) is typically used as a method of producing a membrane (thin film) structure, and silicon nitride (SiN) is mainly used as a material.

In conjunction with the above technique, in a method of manufacturing the CMUT (see, U.S. Patent Publication No. 2005/0177045), after formation of a sacrificial layer, SiN, metal (electrode layer), and SiN are formed on the sacrificial layer, whereby a bend caused by stress is controlled. In another method in which no pattern is formed on the sacrificial layer (see, U.S. Pat. No. 5,894,452), the sacrificial layer is etched while arrangement of etching holes and an etching time are controlled, and thus a vibration film is formed. According to this method, since an upper surface of a vibration film supporting portion and an upper surface of the vibration film can be substantially the same, the bend of the vibration film caused by stress is supposed to be suppressed.

### SUMMARY OF THE INVENTION

In a capacitive micromachined ultrasonic transducer, variation in size of a membrane deteriorates the performance of an element; therefore, in a method using a surface micromachining technique, in general, a thin film is formed after a sacrificial layer is formed by patterning, and then the sacrificial layer is etched. In this case, an uneven flatness with substantially the same thickness as the sacrificial layer may be formed between a portion film-formed on the sacrificial layer and a portion film-formed on a portion other than the sacrificial layer, and in a cross section of a cell, an uneven flatness with substantially the same thickness as the sacrificial layer may be formed between the vibrating film supporting portion and the vibrating film. This uneven flatness easily causes an increase in a bend caused by stress of a vibration film formed of a thin film and an electrode. In such a case, when the stress of the vibration film has a distribution in an element or between elements, a bend distribution of the vibration film occurs. This becomes a distribution of a distance between upper and lower electrodes and leads to variation in a conversion efficiency of an element. Since the ultrasound transducer transmits or receives an ultrasound signal, using a plurality of elements, if the conversion efficiency varies, the performance is significantly reduced, due to the occurrence of intensity variation and phase deviation in an ultrasonic wave being transmitted and the presence of distribution in a received signal. In the capacitive micromachined ultrasonic transducers, higher conversion efficiency can be realized by reducing the distance between electrodes. In this case, bend variation of the vibrating film can be variation between electrodes, and therefore, in order to realize an ultrasound transducer with uniform performance and high conversion efficiency, the bend variation of a membrane is required to be reduced. In the technique disclosed in the U.S. Patent Publication No. 2005/0177045, although variation of a cavity diameter of a cell can be reduced, it cannot be said that the bend caused by the stress of the vibration film can be satisfactorily suppressed. On the other hand, in the technique disclosed in the U.S. Pat. No. 5,894,452, although the bend caused by the stress of the vibration film can be suppressed, since the cavity diameter of the cell is determined by controlling etching, the cavity diameter of the cell easily varies.

In view of the problem, an electromechanical transducer according to the present invention has a plurality of cells constituted of a first electrode, a vibration film including a second electrode provided to face the first electrode through a gap, and a supporting portion supporting the vibration film. A structure is provided at an outer peripheral portion of the gap while a portion of the supporting portion is interposed between the structure and the gap and configured to reduce an uneven flatness between the vibration film and the supporting portion.

In addition, in view of the problem, an electromechanical transducer has a plurality of cells constituted of a first electrode, a vibration film including a second electrode provided so as to face the first electrode through a gap, and a supporting portion supporting the vibration film. According to the present invention, a method of manufacturing the electromechanical transducer includes: forming the first electrode; forming a sacrificial layer on the first electrode; forming a second electrode, insulated from the first electrode, on the sacrificial layer; and removing the sacrificial layer and forming the vibration film including a gap between the first electrode and the second electrode and the second electrode, wherein in the forming the sacrificial layer, a structure configured to reduce an uneven flatness between the vibration film and the supporting portion is formed in a region between the plurality of cells, using a material forming the sacrificial layer.

According to the present invention, the structure as described above is disposed at the outer peripheral portion of the gap to suppress the bend caused by the stress of the vibration film. Consequently, the bend distribution can be reduced when the stress distribution occurs, and the effect of reducing characteristic variation of the electromechanical transducer is provided. When a plurality of electromechanical transducers with less characteristic variation are used as elements, equivalent signals can be received and transmitted in a wide region. For example, transmission and reception without unevenness can be realized at many positions, and it is possible to simultaneously obtain multidimensional ultrasound signals and obtain high-accuracy multi-dimensional physical information of a test subject.

Further features of the present invention will become apparent from the following description of exemplary embodiments with reference to the attached drawings.

### BRIEF DESCRIPTION OF THE DRAWINGS

FIGS. 1A and 1B are views showing an ultrasound transducer as an embodiment of an electromechanical transducer of the present invention.

FIG. 2 is a graph of a relationship between an uneven flatness and a membrane bend explaining the effect of the present invention.

FIG. 3 is a top view of an ultrasound transducer array as another embodiment of the present invention.

FIGS. 4A, 4B, 4C, 4D, 4E, and 4F are views for explaining a method of manufacturing an ultrasound transducer as another embodiment of the present invention.

### DESCRIPTION OF THE EMBODIMENTS

Preferred embodiments of the present invention will now be described in detail in accordance with the accompanying drawings.

The present invention has a feature that a structure configured to reduce an uneven flatness between a vibration film and a supporting portion is provided at an outer peripheral portion of a gap while a portion of the supporting portion is interposed between the structure and the gap. The height of the structure is typically approximately the height of the gap (for example, the height of the gap (for example, 185 nm) to which the height obtained by considering surface roughness (approximately not more than 3 nm) of the gap is referred) in terms of the effect of suppressing the uneven flatness between the vibration film and the supporting portion. However, the height of the structure may be the height out of this range in some cases. However, if the height is too large (for example, the height twice the gap) or too small, the effect cannot be satisfactorily obtained. Consequently, in terms of achieving the effect, it is preferable that the height of the structure is set in accordance with specifications in consideration of materials and structures of other portions. More specifically, the structure may have a height within a range of ±10% of the height of the gap. The outer peripheral portion of the supporting portion as a place where the structure is provided is a place where a portion of the supporting portion is interposed between the structure and a side surface of the gap. However, the outer peripheral portion of the supporting portion is not always limited to the place along the outer circumference surrounding the gap with no space, and a portion of the place may be interrupted as an embodiment to be described later. The formation range of the structure may be determined in accordance with specifications in consideration of materials and structures of other portions in terms of achieving the effect.

Hereinafter, an embodiment of the present invention will be described using the drawings.

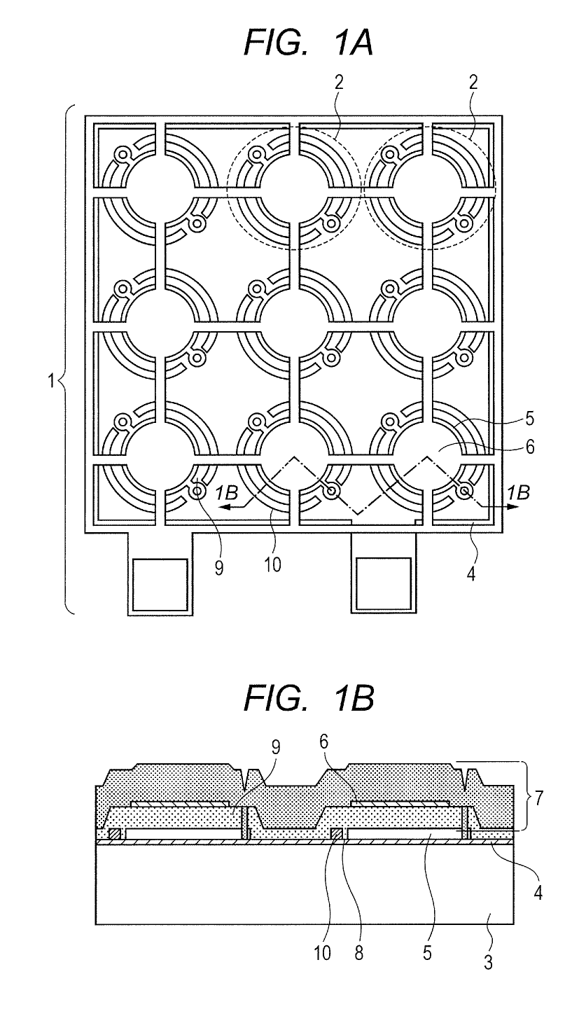

FIGS. 1A and 1B show an ultrasound transducer 1 according to a first embodiment of the present invention. FIG. 1A is a top view of the ultrasound transducer 1, and FIG. 1B is a cross-sectional view thereof along with the dotted line 1B-1B in FIG. 1A. The ultrasound transducer 1 is constituted of a plurality of cells 2. Although the cells 2 are arranged in a square lattice pattern in FIG. 1A, the cells 2 may be arranged in a zigzag pattern, and the arrangement is not limited. The cell 2 is constituted of a first electrode 4 formed on a substrate 3, a gap 5 formed by sacrificial layer etching (such as a gap decompressed from the atmospheric pressure to some extent), a vibration film 7 provided with a second electrode 6 and an insulating layer 9 (first membrane), and a supporting portion 8 supporting the vibration film 7. Although the vibration film 7 has a circular shape in FIG. 1A, the vibration film may have a square shape, a hexagonal shape, or an elliptical shape. The substrate 3 can be a wafer used for manufacturing typical integrated circuits and optical devices, which may be formed of silicon (Si), gallium arsenide (GaAs), glass (SiO₂), SiC, or Silicon-on-Insulator (SOI). The first electrode 4 and the second electrode 6 can be metal thin films and may be formed of, for example, Al, Ti, Co, Cu, Mo, W, or a compound thereof such as AlSi, AlCu, AlSiCu, TiW, TiN, and TiC. The first electrode 4 may be insulated from the substrate 3 or connected to the substrate 3 as long as the substrate is formed of a material conducting electricity. The substrate 3 may be integrated with the first electrode 4, and a silicon (Si) substrate itself may be functioned as the first electrode.

In the cell 2, each of the first electrodes 4 and each of the second electrodes 6 are electrically connected to one another in the ultrasound transducer 1, and the first electrode 4 and the second electrode 6 are insulated by the insulating film 9. The ultrasound transducer 1 electrically functions as a capacitor, and the capacitance is temporally varied by the movable vibration film 7. The vibration film 7 is periodically vibrated to generate the ultrasonic wave. Conversely, when the vibration film 7 receives the ultrasonic wave, the vibration film 7 vibrates, and an alternating current is generated in an electrode.

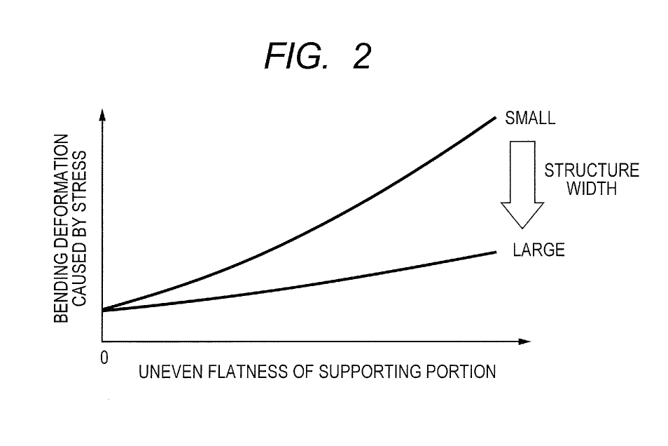

In order to solve the above mentioned problem, in the present embodiment, a structure 10 is disposed at the outer peripheral portion of the supporting portion 8 (namely, a portion of the supporting portion 8 is interposed for a gap 5 around the gap 5). Usually, the supporting portion 8 is integrated with the insulating film 9 of the vibration film 7, and as shown in FIG. 1B, the supporting portion 8 is formed on the first electrode 4 which is formed on the substrate 3, on an insulating film which is formed on the first electrode 4, or on the substrate to thereby support the vibration film 7. In this embodiment, as described above, the structure 10 exists separately from the gap 5 at a portion of the supporting portion 8. The existence of the structure 10 reduces an uneven flatness which is formed in the upper portion of the supporting portion 8 and which is corresponding to a height of a sacrificial layer. As seen in FIG. 2 showing the relationship between this uneven flatness and a bend of the vibration film, the effect of the structure 10 is obvious. Namely, as shown in FIG. 2, the larger the width of the structure, the smaller the bend of the vibration film. The direction of the “width of the structure 10” coincides with the normal direction for the side surface of the gap 5 (horizontal direction of FIG. 1B). As described above, in the present embodiment, the cell is constituted of a first electrode, a second electrode provided to face the first electrode through a gap and insulated from the first electrode, a vibration film provided with the second electrode and formed on a gap, and a supporting portion, and the electromechanical transducer has a plurality of cells. A structure is provided at the outer peripheral portion of the supporting portion while a portion of the supporting portion is interposed between the structure and the gap in the width direction, and the structure projects from a level of a bottom surface on the first electrode side of the gap toward a level at which the second electrode exists, in order to reduce the uneven flatness of the vibration film and the supporting portion. For example, the height of the structure from the level of the bottom surface of the gap is equal to the height of the gap.

Although the structure 10 is away from the gap 5 in the width direction, the structure 10 exists at a distance not more than twice the height of the gap. Although the vibration film 7 and the supporting portion 8 are formed by a layer film-formed on the gap 5, the thickness of the vibration film 7 is required to be approximately twice the height of the gap 5 in order to coat the gap 5 completely. When the distance between the structure 10 and the gap 5 is equal to or smaller than the minimum thickness of the vibration film 7, a portion between the structure 10 and the gap 5 can be buried by a portion of the supporting portion 8, and the uneven flatness can be reduced. When the distance further increases, an uneven flatness is formed in an upper portion of the supporting portion regardless of presence of the structure 10, and therefore, the effect is reduced. Namely, it is preferable that the distance between the structure and the gap in such a state that a portion of the supporting portion is interposed therebetween is not more than twice the height of the gap and the width of the structure in the normal direction for the side surface of the gap is not less than the thickness of the vibration film. In FIG. 1A, although each of the structures 10 exists near the outer circumference of each of the cells 2, the structures may be connected to be integrated with each other between the cells.

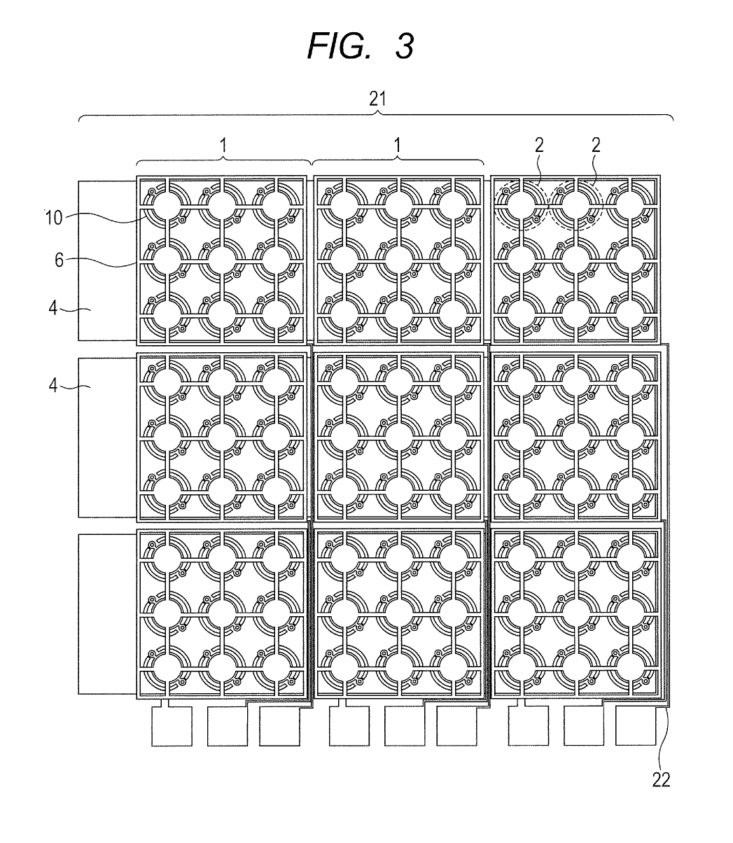

FIG. 3 shows an ultrasound transducer array 21 according to a second embodiment of the present invention. The ultrasound transducer array is an electromechanical transducer in which the ultrasound transducers 1 as shown in FIG. 1A are one-dimensionally or two-dimensionally arranged in a horizontal direction. Although the ultrasound transducers 1 are two-dimensionally arranged in a square lattice pattern in FIG. 3, the ultrasound transducers 1 may be arranged in a zigzag pattern, a hexagonal lattice pattern, or the like. Similarly, in FIG. 3, although the ultrasound transducer 1 has a square shape, the ultrasound transducer 1 may have a circular shape, a hexagonal shape, a reed shape, or the like. The structure 10 may exist over a plurality of the ultrasound transducers (hereinafter also referred to as elements). Namely, the structure 10 is not required to be separated by an element. At this time, in order to prevent crosstalk between the signals of the ultrasound transducers 1, the structure 10 is required to be electrically floated or insulated. In the configuration of FIG. 3, the second electrode 6 of each element is drawn by a signal line 22.

The transducer array which is an electromechanical transducer configured so that the elements including one or more cells are arranged can perform at least one of receiving elastic waves simultaneously with the elements and transmitting the elastic waves simultaneously from the elements. By virtue of the use of the electromechanical transducers with less characteristic variation as elements, equivalent signals can be received and transmitted in a wide region, and it is possible to obtain multidimensional ultrasound signals simultaneously and obtain high-accuracy multi-dimensional physical information.

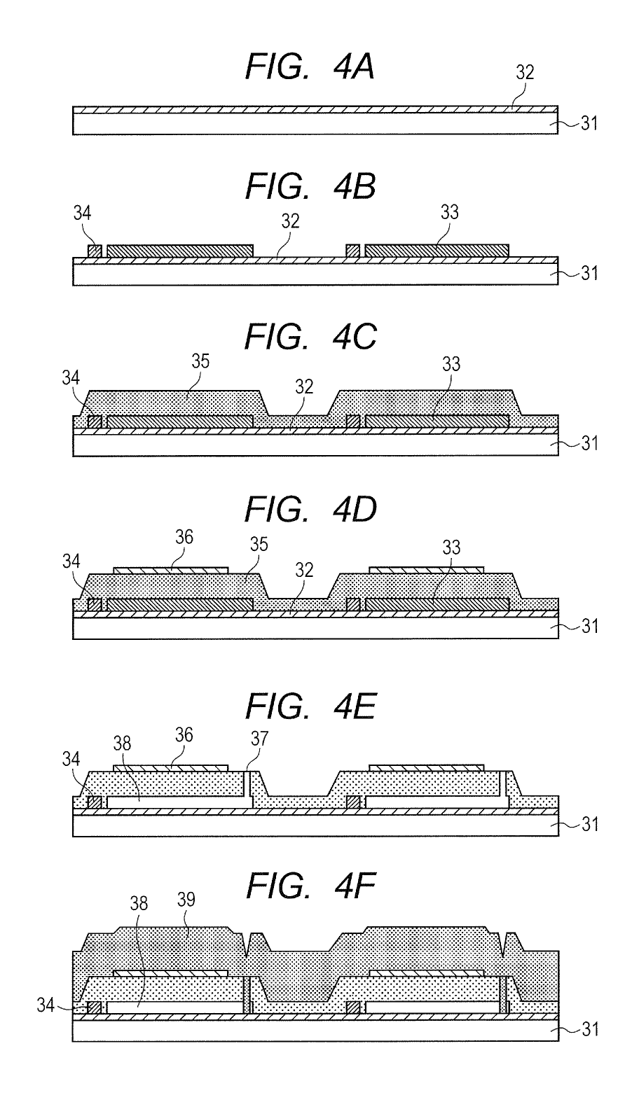

Next, a third embodiment according to a method of manufacturing the above ultrasound transducer will be described using FIGS. 4A, 4B, 4C, 4D, 4E, and 4F. A similar method as of the manufacture of an ultrasound transducer as below can be applied for manufacturing an ultrasound transducer shown in FIG. 3 as an array element, that is, the similar method can be applied to the manufacture of a transducer array.

First, a first electrode 32 is formed on a substrate 31 by film-formation of a conductor, photolithography, and patterning (FIG. 4A). At this time, the first electrode 32 and the substrate 31 may be electrically connected to or insulated from each other. Next, a sacrificial layer 33 is formed by film formation on the first electrode 32, photolithography, and patterning (FIG. 4B). An insulating film may be provided between the first electrode 32 and the sacrificial layer 33. The material of the sacrificial layer 33 is required to have a good processing selection ratio with the surrounding materials and small variation in patterning, considering that the sacrificial layer determines a cavity (gap) shape. Simultaneously with the formation of the sacrificial layer 33, a structure 34 is formed. According to this constitution, the number of processes is not increased, and the configuration capable of achieving the effects of the present invention is manufactured. Next, a first membrane 35 is formed on the sacrificial layer 33 and the structure (FIG. 4C). Subsequently, a second electrode 36 is formed by the film-formation of the conductor, photolithography, and patterning (FIG. 4D).

Next, a hole 37 is formed in the first membrane 35 to expose a portion of the sacrificial layer 33. Then, the sacrificial layer 33 is etched to form a gap 38 (FIG. 4E). After that, the hole 37 is sealed, and, at the same time, a second membrane 39 is film-formed (FIG. 4F). Alternately, there may be used a method including forming the second electrode 36, forming a second membrane after the formation of the second electrode 36, forming a hole in the second membrane and the first membrane, performing sacrificial layer etching, and sealing the hole. As described above, the manufacturing method of the present embodiment includes a process of forming the first electrode, a process of forming the sacrificial layer, a process of forming the second electrode insulated from the first electrode, and a process of removing the sacrificial layer and forming a vibration film including a gap between the electrodes and the second electrode. In the process of forming the sacrificial layer, the structures projecting from the level of the bottom surface on the first electrode side of the gap toward a level at which the second electrode exists, in order to reduce an uneven flatness between a vibration film and a supporting portion, are simultaneously formed in a region between a plurality of the cells, using a material forming the sacrificial layer.

Hereinafter, the present invention will be described in detail by more specific examples.

### EXAMPLE 1

### Transducer Including Structure

In FIG. 1B representing an ultrasound transducer as a first example of the present invention in the best manner, the height of the gap 5 formed by the sacrificial layer 33 (see, FIGS. 4C, 4D and 4E) is 100 to 300 nm. When the vibration film 7 or the gap 5 has a circular shape, the diameter thereof is 20 to 70 nm. In the example of FIG. 1B, although the vibration film 7 has a trilaminar structure including the second electrode 6, portions other than the second electrode 6 may be formed of silicon nitride, diamond, silicon carbide, oxide silicon, polysilicon, and so on. When the vibration film 7 is mainly formed of silicon nitride film formed by Plasma-enhanced-chemical-vapor-deposition (PECVD), the thickness of the vibration film 7 is approximately 500 nm to 2000 nm. The thickness of the second electrode 6 may be less than 20% of the entire vibration film 7. This is because the influence of a bend generated from the stress according to an electrode material can be reduced. Silicon nitride has a good controllability for a bend and therefore it is a preferable material.

The first electrode 4 and the second electrode 6 are required to be insulated from each other, and if the vibration film 7 is silicon nitride, they can be insulated from each other. Alternatively, another insulating layer may be provided between the first electrode 4 and the gap 5. The material of the structure 10 may be the same as or different from the sacrificial layer material. When the material of the structure 10 is the same as the sacrificial layer material, the number of processes is not increased regardless of the presence of the structure 10, and the structure 10 having the height the same as the height of the gap 5 can be disposed. The materials of the sacrificial layer and the structure 10 are determined by a material constituting the vibration film 7, a processing selection ratio with the material, and a processing temperature. The materials may be, for example, chrome, molybdenum, aluminum, compounds thereof, polysilicon, amorphous silicon, oxide silicon, or silicon nitride.

As seen in the graph of FIG. 2, the smaller the uneven flatness, the better, and therefore, the height of the structure 10 may be of a comparable height to the gap 5 with reference to the bottom surface of the gap 5. Concurrently, FIG. 2 shows that the larger the width in the horizontal direction of the structure 10, the smaller the bend, and it is preferable that the width is not less than the thickness of the vibration film 7. If the side surface of the gap 5 has, vertically, a width of not less than the thickness of the vibration film 7, there is the effect of reducing the bend. It is preferable that the structure 10 exists from the side surface of the gap 5 in the horizontal direction (the width direction) at a distance of not more than twice the height of the gap 5, while a portion of the supporting portion 8 is interposed. As the distance between the structure 10 and the gap 5, it is more preferable that the structure 10 exists at a distance of not more than the height of the gap 5. Not only when the structure 10 exists just beside the cell 2, it can have a similar effect even though the structure 10 exists between the cells 2.

In this example, a high-performance ultrasound transducer having high conversion efficiency can be realized by the effect of suppressing bend distribution/variation of the vibration film caused by distribution of stress.

### EXAMPLE 2

### Transducer Array

An ultrasound transducer array as a second example of the present invention will be described. This example is a variation of the first example. In FIG. 3 representing this example, the length of one side of the entire size of an array 21 is 10 to 40 mm, and the ultrasound transducers (elements) 1 are one-dimensionally or two-dimensionally arranged therein. The internal constitution of the ultrasound transducer is equivalent to that in the example 1. Although there are wirings for inputting a drive signal from outside to each transducer or outputting a received signal, the wirings are changed according to an object of the ultrasound transducer array. In an example in FIG. 3, the ultrasound transducers 1 are arranged in a two-dimensional square lattice pattern. For example, when one side of the ultrasound transducer 1 is 1 mm and a square two-dimensional array with one side of 20 mm is used, the size is 20 mm×20 mm.

In the ultrasound transducer array 21 having the above size, when there is distribution in the stress of the vibration film 7 in FIG. 1B, the stress distribution is a factor of the characteristic variation between the ultrasound transducers 1. However, the variation between the ultrasound transducer 1 of the inter-electrode distance can be reduced by the effect of the structure 10. The structure 10 may exist over the two ultrasound transducers 1. According to this constitution, the effect similar to the effect on the cell 2 in the ultrasound transducer 1 can be applied to the cell 2 at the outermost circumference of the ultrasound transducer 1, and, at the same time, the structure can be disposed without keeping a distance from the adjacent ultrasound transducer 1.

In this example, the characteristic variation of the ultrasound transducer array constituted of a plurality of ultrasound transducers can be reduced. As a result, an ultrasound having less intensity variation is generated, and an ultrasound transducer array having a large sound receiving area can be realized. Consequently, equivalent signal reception and signal transmission free from unevenness can be performed in a wide region, and transmission and reception of a high-definition high-dimensional ultrasound signal can be performed.

### EXAMPLE 3

### Manufacturing Method

A method of manufacturing an ultrasound transducer as a third example of the present invention will be described. In general, a capacitive micromachined ultrasonic transducer is manufactured by applying a semiconductor manufacturing process. In the manufacturing method in this example, in particular, a surface micromachining technology based on sacrificial layer etching is used. In FIGS. 4A, 4B, 4C, 4D, 4E, and 4F representing this example in the best manner, although the substrate 31 is preferably a single-crystal silicon substrate, the substrate 31 can be manufactured similarly, even though a glass substrate, an SC)I substrate, or the like is used.

A conductor is film-formed on the substrate 31 by vacuum deposition, a CVD method, or a film-formation method such as sputtering and plating, and the first electrode 32 is formed by photolithography and etching (FIG. 4A). The configuration of the first electrode 32 is required to have a low electrical resistance, heat resistance, and smoothness. From the above, when a silicon substrate or an SOI is used, Si itself may be the first electrode. Alternatively, the first electrode may be constituted of high melting metal such as Ti, Mo, and W or a compound of them, and moreover, the first electrode may be constituted using them as a barrier. However, in order to satisfy the smoothness, in the manufacturing with film-formation, a film thickness is required to be much reduced. Naturally, the subsequent process selectivity is also required. In this example, Ti as the first electrode is film-formed by vacuum deposition or sputtering so as to have a thickness of 50 to 100 nm. Alternatively, Ti is film-formed so as to have an extra thickness and then polished, whereby Ti may be planarized. When the substrate 31 is a single-crystal silicon substrate, a film obtained by previously film-forming a silicon oxide film with a thickness of 0.5 to 2.0 μm in a thermal oxidation process is used. Consequently, the first electrode can be separated and formed by patterning.

Next, a sacrificial layer is formed (FIG. 4B). Before the formation process, an insulating layer may be film-formed by CVD or the like. The thickness of the sacrificial layer is 100 to 300 nm as described above. The configuration of the sacrificial layer 33 is required to have an etching selectivity, heat resistance, smoothness, and etching uniformity. A pattern of a sacrificial layer is formed by photography and etching. The shape of the gap 5 in FIG. 1A is determined in this pattern. The gap 5 may have a circular shape, a square shape, or a hexagonal shape. For example, when the gap 5 has a circular shape, the diameter is 20 to 70 μm. The materials used in the sacrificial layer include Cr, Mo, amorphous Si, and oxide silicon. In the configuration required for the structure 34, regarding the material, any extra requirement is not necessary for the sacrificial layer 33. For example, the structure 34 may be of a comparable thickness to the sacrificial layer 33 and have the positional relationship for the sacrificial layer 33, which is the gap 38, and the above size.

In this example, the structure 34 is formed simultaneously with the formation of the sacrificial layer 33. Consequently, the ultrasound transducer 1 providing the above effects can be manufactured without increasing the number of processes. After the formation of the sacrificial layer 33 and the structure 34, the first membrane 35 is film-formed on the sacrificial layer 33 and the structure 34 (FIG. 4C). A material as a membrane is required that it is light and hard, stress control is easy, and thickness distribution is small. For example, a nitride silicon film with a thickness of 400 to 700 nm is formed by PECVD. The stress may be in a range of 0 to 150 MPa. Although it is not necessary when the first membrane 35 is an insulator, when a semiconductor or a conductive material, for example polysilicon, is selected, an insulating film is required to be provided between the first electrode and a second electrode to be described later. In this case, it is essential to film-form an insulating layer before the formation of the sacrificial layer 33 and the structure 34.

After the film-formation of the first membrane 35, a conductor is film-formed by vacuum deposition, a CVD method, sputtering or plating, and the second electrode 36 is formed by photolithography and etching (FIG. 4D). The configuration of the second electrode 36 is required to have an etching selectivity, heat resistance, etching uniformity, low stress, and low resistance. The heat resistance is required because a sealing film will be formed in the later procedure. Since an electrode area is a variable of a capacitance, etching variation is required to be small. However, in dry etching based on reactive ion etching, the selectivity is typically small, and even through the first membrane 35 is protected by photoresist, the material of the first membrane 35 may be damaged. Consequently, when the stress increases, the vibrating film is bent, and it is difficult to control the height of the gap 5. From the above, the optimum material of the second electrode 36 is Ti, Mo, W, or a compound of them, and even when a low melting metal such as Al is used, it is essential to use Ti, TiN, and so on as a barrier metal. At the same time, if the second electrode 32 is thick for the first membrane 35, a bend caused by stress occurs, and sacrificial layer etching in the subsequent process becomes difficult in some cases. The thickness of the second electrode 32 may be 50 to 200 nm. Although the area of the second electrode 36 on the first membrane 35 is smaller than the area of the sacrificial layer 33 in FIG. 4C, the area of the second electrode 36 may be larger than the area of the sacrificial layer 33.

Subsequently, a hole 37 is formed in the first membrane 35 to expose the sacrificial layer 33. Then, the sacrificial layer 33 is etched, and the gap 38 is formed (FIG. 4E). After that, the hole 37 is sealed, and, at the same time, the second membrane 39 is film-formed (FIG. 4F). Since the second membrane 39 is required to keep sealing adhesiveness, enable to control stress, and have uniformity, it is preferable that the second membrane 39 is formed of the same material as the first membrane 35. For example, a nitride silicon film is formed by CVD. At this time, the second membrane 39 is required to have a thickness of not less than a thickness large enough to bury an uneven flatness caused by the height of the gap 38, and the height of the second membrane 39 may be in a range from 600 to 1500 nm.

Alternatively, there may be used a manufacturing method including forming the second electrode 36, forming a second membrane after the formation of the second electrode 36, forming a hole in the second membrane and the first membrane, performing sacrificial layer etching, and sealing the hole. If this method is used, the etching selectivity of the second electrode 36 does not matter. Further, the second membrane 39 in a portion other than the circumference of the hole 37 is etched, whereby the thickness of the second membrane 39 may be reduced. According to this example, an ultrasound transducer having high conversion efficiency and an ultrasound transducer array with less characteristic variation can be manufactured.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-202494, filed Sep. 16, 2011, which is hereby incorporated by reference herein in its entirety.

What is claimed is:

1. An electromechanical transducer, which has a plurality of cells constituted of a first electrode, a vibration film comprising a second electrode provided to face the first electrode through a gap, and a supporting portion supporting the vibration film, comprising
a structure which is provided at an outer peripheral portion of the gap while a portion of the supporting portion is interposed between the structure and the gap and configured to reduce an uneven flatness between the vibration film and the supporting portion.

2. The electromechanical transducer according to claim 1, wherein the structure projects from a level of a bottom surface on the first electrode side of the gap toward a level at which the second electrode exists.

3. The electromechanical transducer according to claim 2, wherein the height of the structure from the level of the bottom surface of the gap is equal to the height of the gap.

4. The electromechanical transducer according to claim 1, wherein a distance between the structure and the gap in such a state that a portion of the supporting portion is interposed therebetween is not more than twice the height of the gap, and
the width of the structure in the normal direction of the side surface of the gap is not less than the thickness of the vibration film.

5. A transducer array comprising a plurality of the electromechanical transducers according to claim 1 arranged as elements including one or more of the cells and
performing at least one of receiving elastic waves with the plurality of elements and transmitting the elastic waves from the elements.

6. A method of manufacturing an electromechanical transducer, which has a plurality of cells constituted of a first electrode, a vibration film comprising a second electrode provided so as to face the first electrode through a gap, and a supporting portion supporting the vibration film, comprising:
forming the first electrode;
forming a sacrificial layer on the first electrode;
forming a second electrode, insulated from the first electrode, on the sacrificial layer; and
removing the sacrificial layer and forming the vibration film comprising a gap between the first electrode and the second electrode and the second electrode,
wherein in the forming the sacrificial layer, a structure configured to reduce an uneven flatness between the vibration film and the supporting portion is formed in a region between the plurality of cells, using a material forming the sacrificial layer.

7. The method of manufacturing an electromechanical transducer according to claim 6, wherein the structure is formed so as to project from a level of a bottom surface on the first electrode side of the gap toward a level at which the second electrode exists.

8. The method of manufacturing an electromechanical transducer according to claim 7, wherein the structure is formed so that the height from the level of the bottom surface of the gap of the structure is equal to the height of the gap.
